(19) United States
(12) Patent Application Publication
(10) Pub. No.: US 2012/0301132 A1
(43) Pub. Date: Nov. 29, 2012

(54) CAMERA BLOCKER FOR A DEVICE WITH AN INTEGRATED CAMERA THAT USES A THIN FILM ORGANIC POLYMER

(75) Inventors: Thor F. R. Mitskog, Austin, TX (US); Richard Anthony Ralston, Austin, TX (US)

(73) Assignee: HT RESOURCES, INC., Austin, TX (US)

(21) Appl. No.: 13/477,485

(22) Filed: May 22, 2012

Related U.S. Application Data
(60) Provisional application No. 61/488,968, filed on May 23, 2011.

(51) Int. Cl. G03B 17/00; B32B 37/12

(52) U.S. Cl. 396/448; 156/331.7

(57) ABSTRACT

This disclosure describes a camera blocker for a device with an integrated camera that uses a thin film organic polymer. The disclosed invention comprises a microfiber top coupled to a polyurethane base. The microfiber top is adapted to be printed. The polyurethane base is adapted to adhesively stick to any surface without leaving a sticky residue and is reusable. And, the camera blocker is adaptable to be shaped.

### CROSS REFERENCE TO RELATED APPLICATIONS

This application claims priority and the benefits of the earlier filed Provisional No. 61/488,968, filed May 23, 2011, which is incorporated by reference for all purposes into this specification.

### TECHNICAL FIELD

The present invention in general relates to camera blockers for devices with integrated cameras. More specifically, the present invention relates to a camera blocker for a device with an integrated camera that uses a thin film organic polymer that acts as a camera blocker, is reusable, non-sticky and can be cut into any shape.

### BACKGROUND ART

In today's world, digital cameras have become very ubiquitous and are now found integrated into a variety of devices. Unfortunately, one down side of having integrated cameras everywhere is that the threat of spying, computer peeping, or video monitoring has become a growing problem. There are numerous reports of companies spying on employees in their homes, tech support groups spying on customers, schools monitoring children, and customers being tracked with their smart phones and tablets. No one has the right to monitor you in your home without your consent.

As these types of cameras get smaller and smarter, maintaining your privacy is more important than ever. Major companies such as Apple, Dell, HP and Google have had reported incidents of spying on customers and employees through webcams on theft computers, smart phones, and tablets. The problem of spying through webcams has even resulted in federal lawsuits with a major retailer such as Aarons Inc. This lawsuit claims that the company employees spied on a customer that purchased an HP notebook with an integrated webcam and captured photos of the customer while in their home.

Additionally, Dell Corporation made formal apologies to customers for technical support teams remotely turning on Dell customer's notebooks web cameras capturing photos. And, Apple's “IPhone 4 glitch” reportedly captured unauthorized photos from customer's i-phones. Google and Apple have been in the news with tracking customer locations and user activity. People wonder to what level are they being tracked. It's not just that they are only nervous about companies tracking them to market to them, it's that these same devices can be hacked into by anyone.

With cameras everywhere, how do you really know that camera is turned off. One solution is to place paper in front of the camera port. Another solution is to use something like duct tape, which fixes many other problems, but in this case the sticky tape adhesive will spoil the camera lens and damage your laptop, iPhone, or iPad. Another solution requires a first layer of material to be adhered to the camera bezel and is specifically meant for embedded digital cameras in Laptops. Another solution, being primarily mechanical had mechanical problems associated with it, such as hindrance in closing the LCD display and the lack of applicability in respect of digital cameras embedded in tablets and smart phones.

Accordingly, there is a long felt need to design a camera blocker for an integrated device that is applicable in all types of cameras and devices, which is reusable and adhesively sticks to any surface without leaving a sticky residue, can be customized in different geometries and colors, is applicable for all types of digital and non-digital cameras and is simultaneously less costly. The disclosed invention is designed with a unique material that adheres to most surfaces without damaging or leaving a residue on the web camera lens cover. Unlike other materials such as tape, stickers, and post-it notes, all of which leave residue on the web camera lens, the disclosed invention does not leave residue and can be re-used multiple times before needing to be cleaned for more continued use.

### SUMMARY OF INVENTION

This disclosure describes a camera blocker for a device with an integrated camera that uses a thin film organic polymer. The disclosed invention comprises a microfiber top coupled to a polyurethane base. The microfiber top is adapted to be printed. The polyurethane base is adapted to adhesively stick to any surface without leaving a sticky residue and is reusable. And, the camera blocker is adaptable to be shaped.

The disclosed invention provides that the polyurethane base further includes a polyurethane (PE) separator layer of 30 μm thickness, an adhesive acrylic layer of 500 μm thickness, a core layer having polyurethane acrylic film and glue (PET and Acrylate Copolymer) of 80 μm thickness, and a Pater (one side silicon treatment) separator layer of 90 μm thickness.

### DESCRIPTION OF DRAWINGS

To further aid in understanding the invention, the attached drawings help illustrate specific features of the invention and the following is a brief description of the attached drawings:

FIG. 1A illustrates a sectional view of a one embodiment of the camera blocker according to the present invention which is of a square shape.

FIG. 1B illustrates another embodiment of the camera blocker which is of circular shape.

FIG. 2 illustrates a cross-sectional view of the polyurethane base of disclosed invention.

FIG. 3 illustrates the camera blocker being applied to a typical camera lens.

FIG. 4 illustrates removing the camera blocker.

### DESCRIPTION OF EMBODIMENTS

This disclosure describes a camera blocker for a device with an integrated camera that uses a thin film organic polymer. This disclosure describes numerous specific details in order to provide a thorough understanding of the present invention. One skilled in the art will appreciate that one may practice the present invention without these specific details. Additionally, this disclosure does not describe some well known items in detail in order not to obscure the present invention.

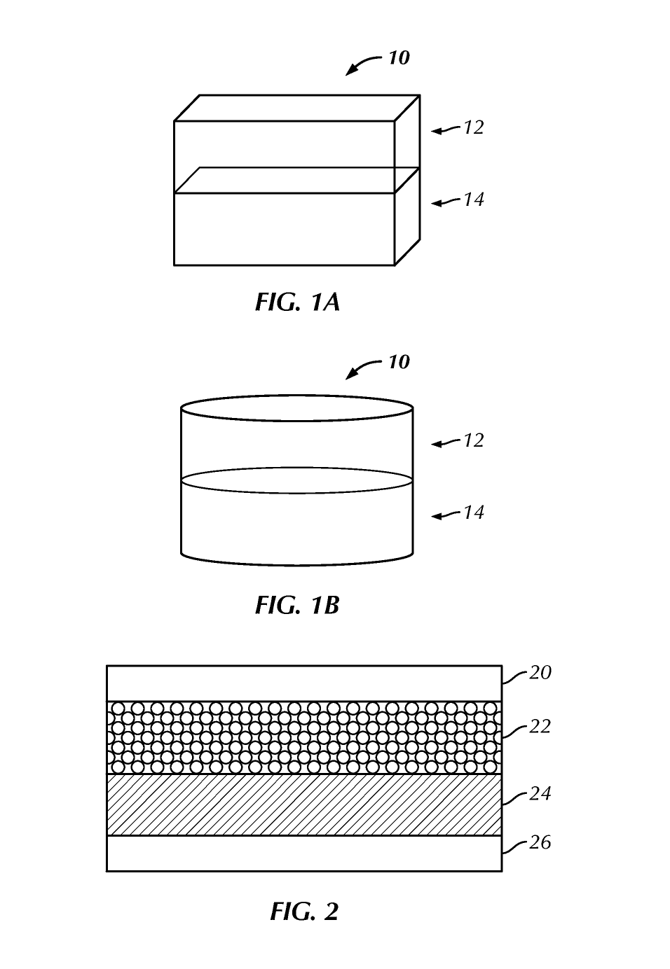

FIG. 1A shows a cross-sectional view of a one embodiment of the disclosed invention. The camera blocker 10 comprises a thin film organic polymer that further comprises a microfiber top 12 and a polyurethane base 14. The microfiber top 12 is printable, for example, various designs and colors may be printed on the top with a variety of suitable printing techniques such as using a thermal color print transfer process. The microfiber top 12 couples to polyurethane base 14 by fusing them together with a high temperature press. One skilled in the art will appreciate that there are multiple ways to couple a microfiber top to a polyurethane base.

The polyurethane base 14 is a polyurethane based blend that is capable of sticking to any surface including an integrated camera lens without leaving any adhesive residue. If the base 14 loses adhesion, it can be reactivated by simply rinsing it in water and letting it dry. The base 14 leaves no residue and does not damage the camera lens. It can be used for approximately 200,000 cycles of covering and uncovering the lens camera.

The camera blocker 10 can be cut into any shape such as with a the cut using an electrode charge knife outlined into the geometric shape desired. And, as described above, the camera blocker 10 can be printed in any color or with any pattern. FIG. 1A shows an embodiment of camera blocker 10 where the section is a square shaped. FIG. 1B shows another embodiment camera blocker 10 having a circular shaped cross-section.

FIG. 2 illustrates a cross-sectional view of the polyurethane base 14 of the disclosed invention. The thin film organic polymer polyurethane base 14 comprises a number of layers that are sandwiched together such as found in a YGTQ Pita Organic Polymer Sheet or a P-Touch Sheet. The first layer 20 comprises a polyurethane (PE) separator layer of 30 μm thickness. The next layer 22 comprises an adhesive acrylic layer of 500 μm thickness. The next layer 24 comprises a core layer having polyurethane acrylic film and glue (PET and Acrylate Copolymer) of 80 μm thickness. And finally, layer 26 is a Pater (one side silicon treatment) separator layer of 90 μm thickness. One skilled in the art will appreciate that other constructions of the base 14 are possible with the understanding that the materials need to be capable of reuse and not leave any residue behind as described elsewhere in this disclosure.

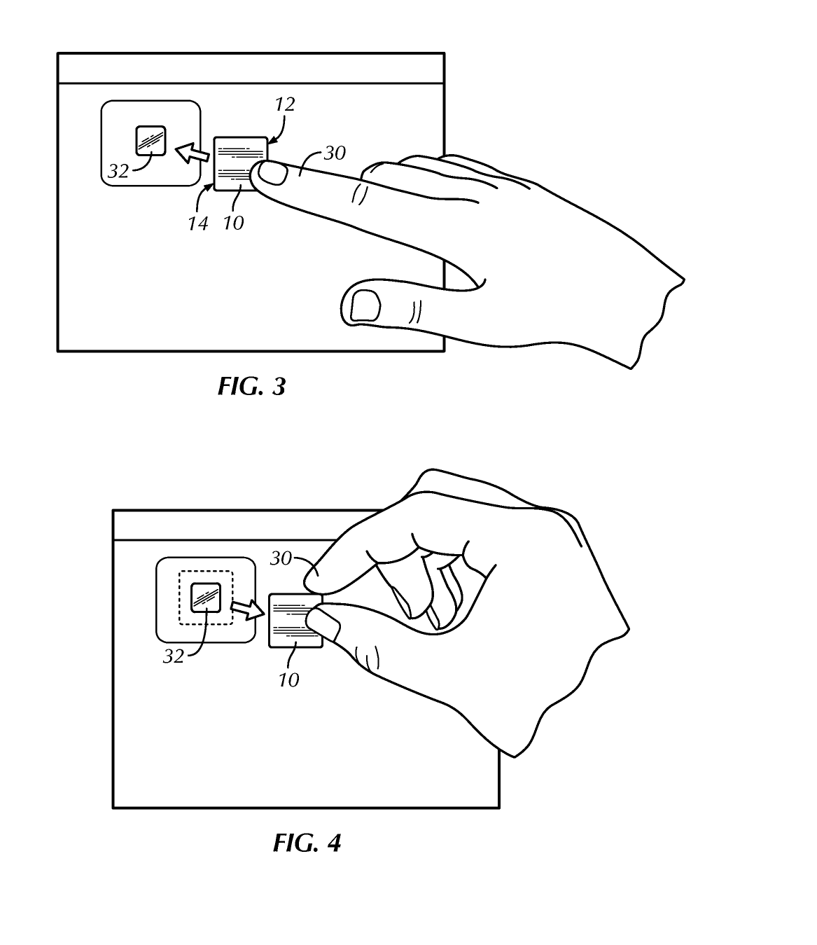

FIG. 3 illustrates the camera blocker being applied to a typical camera lens of an integrated camera of a mobile device. As previously illustrated, camera blocker 10 comprises microfiber top surface 12 and a polyurethane base 14. The user 30 takes the camera blocker 10 and applies it over the camera lens 32 of an integrated camera for a mobile device. The disclosed invention forms a barrier preventing the integrated camera from transmitting images and/or video.

FIG. 4 illustrates removing the camera blocker. The user 30 removes the camera blocker 10 from the camera lens 32. The user 30 can place the camera blocker 10 and to stick it to any other surface for later reuse.

To summarize, this disclosure describes a camera blocker for a device with an integrated camera that uses a thin film organic polymer. The disclosed Invention comprises a microfiber top coupled to a polyurethane base. The microfiber top is adapted to be printed. The polyurethane base is adapted to adhesively stick to any surface without leaving a sticky residue and is reusable. And, the camera blocker is adaptable to be shaped.

The disclosed invention provides that the polyurethane base further Includes a polyurethane (PE) separator layer of 30 μm thickness, an adhesive acrylic layer of 500 μm thickness, a core layer having polyurethane acrylic film and glue (PET and Acrylate Copolymer) of 80 μm thickness, and a Pater (one side silicon treatment) separator layer of 90 μm thickness.

Other embodiments of the present invention will be apparent to those skilled in the art after considering this disclosure or practicing the disclosed invention. The specification and examples above are exemplary only, with the true scope of the present invention being determined by the following claims.

1. A camera blocker for a device with an integrated camera that uses a thin film organic polymer, comprising:
a microfiber top; and
a polyurethane base coupled to said microfiber top;
wherein said microfiber top is adaptable to printed;
wherein said polyurethane base is adapted to adhesively stick to any surface without leaving a sticky residue and is reusable;
wherein the camera blocker is adaptable to be shaped; and
wherein the camera blocker is used for devices with integrated cameras.

2. The claim of claim 1 wherein said polyurethane base further comprises a PE separator layer, an adhesive acrylic layer, a core layer PET and Acrylate Co-polymer layer, and a Pater separator layer.

3. The claim of claim 1 wherein said polyurethane base further comprises a polyurethane (PE) separator layer of 30 μm thickness, an adhesive acrylic layer of 500 μm thickness, a core layer having polyurethane acrylic film and glue (PET and Acrylate Co-polymer) of 80 μm thickness, and a Pater (one side silicon treatment) separator layer of 90 μm thickness.

4. A method to make a camera blocker for a device with an integrated camera that uses a thin film organic polymer, comprising:
providing a microfiber top; and
coupling a polyurethane base to said microfiber top;
wherein said microfiber top is adapted to be printed;
wherein said polyurethane base is adapted to adhesively stick to any surface without leaving a sticky residue and is reusable;
wherein the camera blocker is adaptable to be shaped; and
wherein the camera blocker is used for devices with integrated cameras.

5. The claim of claim 4 wherein said polyurethane base further comprises a PE separator layer, an adhesive acrylic layer, a core layer PET and Acrylate Co-polymer layer, and a Pater separator layer.

6. The claim of claim 4 wherein said polyurethane base further comprises a polyurethane (PE) separator layer of 30 μm thickness, an adhesive acrylic layer of 500 μm thickness, a core layer having polyurethane acrylic film and glue (PET and Acrylate Co-polymer) of 80 μm thickness, and a Pater (one side silicon treatment) separator layer of 90 μm thickness.

7. A method to use a camera blocker for a device with an integrated camera that uses a thin film organic polymer, comprising:
providing a microfiber top coupled to a polyurethane base; and
attaching or removing the camera blocker to or from devices with integrated cameras;
wherein said microfiber top is adapted to be printed;
wherein said polyurethane base is adapted to adhesively stick to any surface without leaving a sticky residue and is reusable; and
wherein the camera blocker is adaptable to be shaped.

8. The claim of claim 7 wherein said polyurethane base further comprises a PE separator layer, an adhesive acrylic layer, a core layer PET and Acrylate Co-polymer layer, and a Pater separator layer.

9. The claim of claim 7 wherein said polyurethane base further comprises a polyurethane (FE) separator layer of 30 μm thickness, an adhesive acrylic layer of 500 μm thickness, a core layer having polyurethane acrylic film and glue (PET and Acrylate Co-polymer) of 80 μm thickness, and a Pater (one side silicon treatment) separator layer of 90 μm thickness.
